(19) United States
(12) Patent Application Publication
(10) Pub. No.: US 2017/0021771 A1
(43) Pub. Date: Jan. 26, 2017

(54) SUCKER ROD TRAILER

(71) Applicant: Justin Winkler, Williston, ND (US)

(72) Inventor: Justin Winkler, Williston, ND (US)

(21) Appl. No.: 15/177,377

(22) Filed: Jun. 9, 2016

Related U.S. Application Data
(60) Provisional application No. 62/180,206, filed on Jun. 16, 2015.

(51) Int. Cl. B60R 3/00; B60P 3/22

(52) U.S. Cl. CPC B60R 3/005; B60P 3/2215

(57) ABSTRACT

The disclosure provides systems and methods of use pertaining to the storage and transportation of sucker rods used in sucker rod pumps for oil wells. The system includes a flatbed having a protective structure protruding perpendicular from the flatbed on all four sides. A removable cover may be disposed about the protective structure to protect stored rods from negative environmental impacts. The system also includes a fluid containment system and an integrated and detachable catwalk system that allows rig crews to load and unload sucker rods without walking on previously loaded rods or rolling rods across the width of the trailer. Other embodiments are also disclosed.

### REFERENCE TO PENDING PRIOR PATENT APPLICATION

This application claims the benefit under 35 U.S.C. 119(e) of U.S. Provisional Patent Application No. 62/180,206, filed Jun. 16, 2015 by Justin Winkler for “SUCKER ROD TRAILER,” which patent application is hereby incorporated herein by reference.

### BACKGROUND

A sucker rod is a rod, typically made of steel, used in the oil industry to join the surface and downhole components of a reciprocating piston pump installed in an oil well. Sucker rods are typically between 25 and 30 feet in length with threaded ends. Generally, sucker rods are stored and/or transported to the end location using a flatbed trailer long enough to provide support (i.e., to avoid excessive flexing caused by overhang) along the length of the rod. Existing sucker rod trailers are generally twenty-five to thirty foot gooseneck trailers that are open to the environment and suitable for multiple industrial purposes.

To load an existing trailer, rods are placed one by one on top of wooden boards, generally 2-inch×4-inch or 4-inch×4-inch in cross-section. A rig crew carries the rods onto the trailer, walks across the trailer's flatbed, and lays the rods down. Another layer of wooden boards is placed on top of the lower rods before the next rod layer is applied. This process continues until the trailer is fully loaded. As the rod layers begin to stack, the rig crew either walks on top the rods as they lay them down or rolls the rods across the wooden layer from one side of the trailer to the other. Walking on the rods can damage them, creating micro fractures and/or nicks in the metal. Similarly, rolling the rods across the width of the trailer into one another encourages metal-to-metal contact that can cause small abrasions in the metal. Corrosion may attack these weak areas, working its way across the diameter of the rods and creating weak points that ultimately lead to failure.

Existing sucker rod trailers are also open to the environment and exposed to the elements, allowing for rain, snow, dust, pollutants, and other airborne debris to access and attach to the rods. When debris collects in the end couplings of the rods (e.g., the rod boxes and/or the threaded pin ends), the amount of torque required to tighten the rods during pump installation is altered. This prevents the rods from reaching proper torque specifications, a critical parameter in preventing failure.

Sucker rods are often covered with oil and salt water, and existing trailers do not provide a mechanism for containing or controlling run-off in a manner that allows for proper disposal and/or mitigation of slip risk. Current trailers also lack a containment mechanism for other chemicals that might be applied to the rods. Most often, excess oil causes a slip hazard and applied chemicals simply seep off the rods, the trailer, and into the ground.

Given these challenges, existing sucker rod trailers fail to give rig crews a solution that provides for the efficient, non-damaging, and safe laying of rods within a sucker rod trailer for transport and/or storage. Moreover, once loaded, existing trailers fail to protect loaded rods from environmental damage that undermines the longevity and efficacy of the rods.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

One embodiment provides a trailer system for storing and transporting sucker rods. The trailer may include a flatbed having front, back, left, and right sides and a protective structure protruding perpendicular to the flatbed along the front, back, left, and right sides. The trailer may also include a detachable catwalk system protruding parallel to the flatbed along at least the left and the right sides, the catwalk system configured to support a number of users walking along the catwalk.

Another embodiment provides a sucker rod storage and transportation trailer. The sucker rod storage and transportation trailer may include (1) a flatbed sized to receive a number of sucker rods, the flatbed having front, back, left, and right sides; (2) a containment wall abutting the flatbed on the front, back, left, and right sides of the flatbed, the flatbed and the containment wall forming a fluid containment area; (3) a detachable catwalk system bordering the containment wall along at least the left and the right sides of the flatbed, wherein the detachable catwalk system includes a proximal edge and a distal edge relative to the containment wall, and wherein the detachable catwalk system is configured to support one or more users; and (4) a detachable protective structure having a left railing section disposed along the left side of the flatbed, a right railing section disposed along the right side of the flatbed, a front railing section disposed along the front side of the flatbed, and a back railing section disposed along the back side of the flatbed, the left and right railing sections configured to optionally attach at a proximal position located adjacent to the proximal edge of the detachable catwalk system and a distal position located adjacent to the distal edge of the detachable catwalk system.

Yet another embodiment provides a method of storing and transporting sucker rods using a sucker rod trailer having (1) a flatbed sized to receive the sucker rods, the flatbed having front, back, left, and right sides surrounded by a containment wall, the flatbed and the containment wall combining to form a fluid containment area; and (2) a protective structure disposed about the containment wall, the method comprising. Embodiments of the method initiate with removing, from one of a number of storage structures suspended beneath the flatbed, a catwalk section selected from a number of catwalk sections, and attaching the catwalk section adjacent to the left or the right side of the flatbed. The steps of removing the catwalk section and attaching the catwalk section may be repeated until a catwalk system protrudes parallel to the left and the right sides of the flatbed in a manner that supports one or more users. The method may also include loading the trailer by placing a sucker rod within the fluid containment area by walking solely upon the catwalk system. The step of placing the sucker rod may be repeated until all the sucker rods are stacked within the fluid containment area.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 illustrates a side plan view of one embodiment of an improved sucker rod trailer;

FIG. 2 illustrates a perspective view of one embodiment of a flatbed and a portion of a protective structure for the sucker rod trailer of FIG. 1;

FIG. 3 illustrates a top view of one embodiment of the flatbed of FIG. 2, having a fluid containment area;

FIG. 4 illustrates a partial perspective view of the fluid containment area of FIG. 3;

FIG. 5 illustrates a front view of an exemplary side railing section of the protective structure of FIG. 2;

FIG. 6 illustrates a front view of an exemplary back railing section of the protective structure of FIG. 2;

FIG. 7 illustrates a top view of one embodiment of a pin joint for connecting the side railing section of FIG. 5 with the back railing section of FIG. 6;

FIG. 8 illustrates a front view of one embodiment of a front railing section of the protective structure of FIG. 2;

FIG. 9 illustrates a top view of one embodiment of the front railing section of FIG. 10, as attached to the side railing sections of FIG. 5;

FIG. 10 illustrates a perspective view of one embodiment of a removable cover enclosing the protective structure of FIGS. 2 and 5-9;

FIG. 11 illustrates a perspective view of one embodiment of a number of securement straps for the cover of FIG. 10;

FIG. 12 illustrates a perspective view of the protective system of FIGS. 2 and 5-9 enveloped by the cover of FIG. 10;

FIG. 13 illustrates a partial perspective view of one embodiment of a catwalk system for the trailer of FIG. 1;

FIG. 14 illustrates a perspective view of one embodiment of an individual catwalk section of the catwalk system of FIG. 13;

FIG. 15 illustrates a top view of the catwalk section of FIG. 14;

FIG. 16A illustrates a side view of the catwalk section of FIGS. 14-15;

FIG. 16B illustrates a front view of a leverage block of the catwalk section of FIGS. 14-16A;

FIG. 17 illustrates the catwalk system of FIG. 13 having the side railing section of FIG. 5 attached in a first optional configuration;

FIG. 18 illustrates the catwalk system of FIG. 13 having the side railing section of FIG. 5 attached in a second optional configuration;

FIG. 19 illustrates a perspective view of one embodiment of a storage bin for the catwalk section of FIG. 14 in an open configuration;

FIG. 20 illustrates a perspective view of the storage bin of FIG. 19 in a closed configuration;

FIG. 21 illustrates a side view of the storage bin of FIG. 19, as attached to a frame of the trailer; and

FIG. 22 provides a flow chart depicting an exemplary method for storing and transporting sucker rods using the sucker rod trailer of FIG. 1.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

Various embodiments of the systems and methods described herein relate to the storage and transport of sucker rods for use in sucker rod pumps to be installed in oil wells. The system discussed below provides an improved sucker rod trailer that includes several components designed to facilitate safe and non-damaging rod loading, storage, and transport procedures.

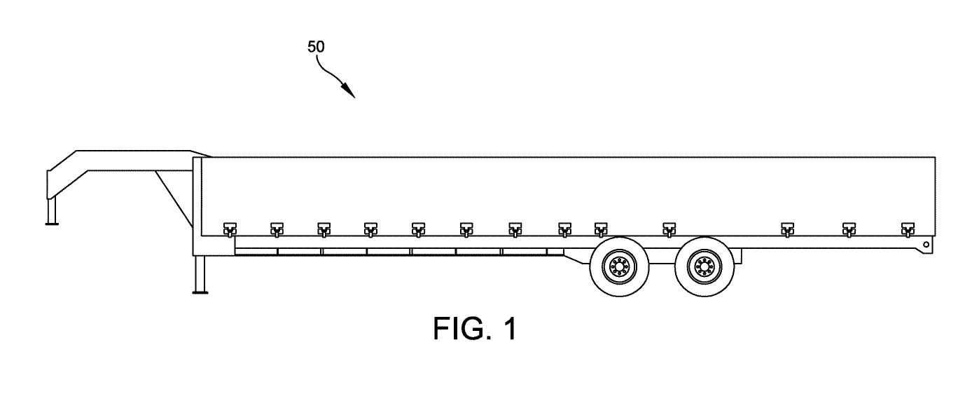

FIG. 1 illustrates a side view of an improved sucker rod trailer 50. In this embodiment, sucker rod trailer 50 encompasses several component systems, detailed below, which include a containment wall/area for fluid management, a protective structure and removable cover for environmental protection, and a catwalk system designed for access to the trailer to facilitate the safe and non-damaging loading and unloading of sucker rods.

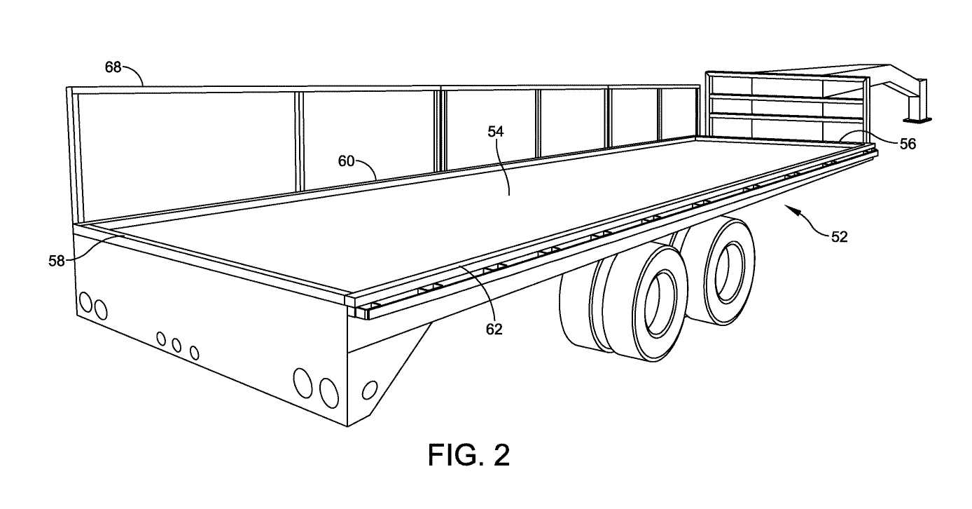

FIG. 2 illustrates a perspective view of a base trailer 52 (e.g., a gooseneck trailer) having a flatbed 54 with front, back, left, and right sides 56, 58, 60, and 62, respectively. Flatbed 54 serves as the base for the component systems discussed above.

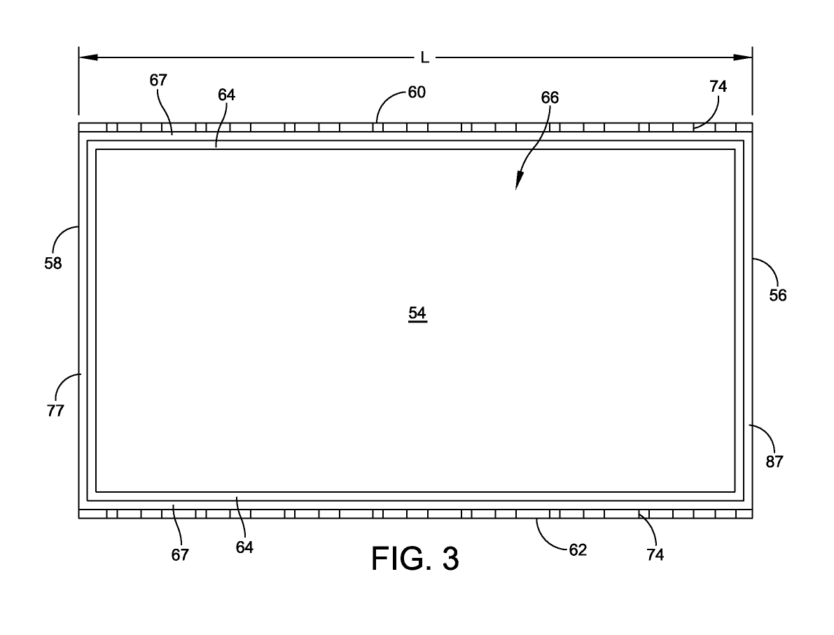

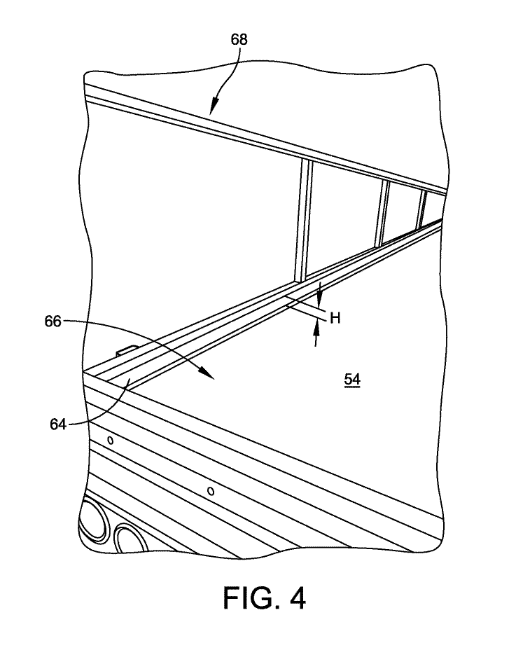

FIGS. 3-4 illustrate top and partial-perspective views of flatbed 54, which features a containment wall 64 bordering flatbed 54 along each of its sides 56, 58, 60, and 62. In one embodiment, flatbed 54 may have a length, L, of approximately thirty feet (FIG. 3), though flatbed 54 may be longer or shorter depending on sucker rod length. Containment wall 64 may combine with flatbed 54 to create a fluid containment area 66 to catch any accumulated fluid that is shed from loaded sucker rods (e.g., oil) or any chemical additives sprayed upon loaded sucker rods, thereby allowing excess fluid to be properly managed, collected, and disposed of. In one embodiment, containment wall 64 may have a height, H, of approximately 2 inches to ensure fluid containment (FIG. 4), and fluid containment area 66 may be coated or layered with a fluid and/or chemical resistant material to protect flatbed 54. When level, and in one embodiment, containment area 66 may hold approximately seven petroleum barrels (bbls) of fluid.

FIGS. 2-4 also illustrate a protective structure 68 that may be disposed along flatbed 54 on all sides 56, 58, 60, and 62. In one embodiment, protective structure 68 may protrude from flatbed 54 in a direction perpendicular to flatbed 54. Protective structure 68 may be formed from a number of connected railing sections, including side railing sections 67, a back railing section 77, and a front railing section 87 (FIG. 3). Each railing section may have any appropriate length required to border each side 56, 58, 60, and 62 of flatbed 54/containment wall 64 in continuous or segmented portions.

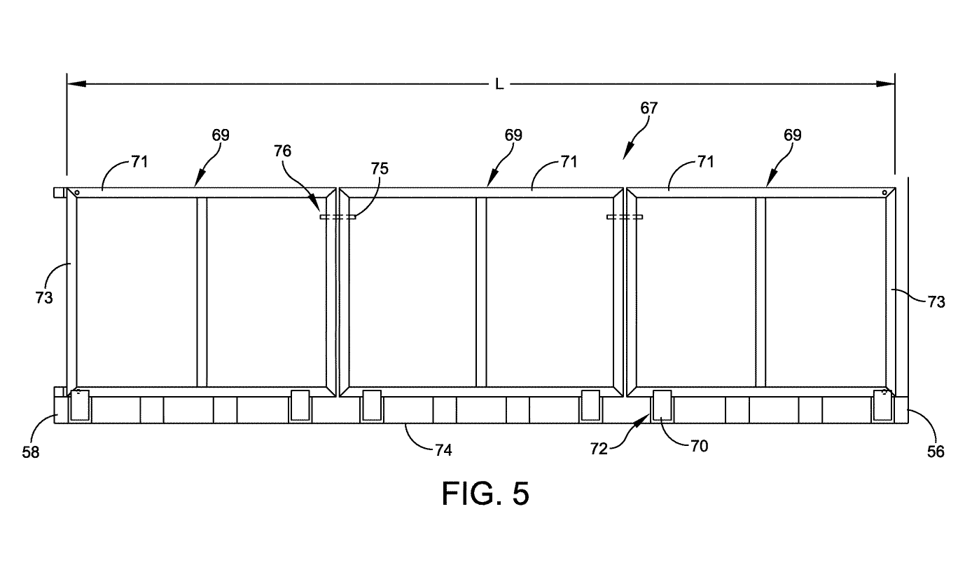

In further detail, FIG. 5 shows a front view of one embodiment of side railing section 67 of protective structure 68. In this embodiment, side railing section 67 may include a series of three side rail portions 69 for attachment to left side 60 and right side 62 of flatbed 54. Each side rail portion 69 may be formed of lateral and vertical rails 71, 73, respectively. Lateral and vertical rails 71, 73 may be formed of 2-inch×2-inch steel box tubing, welded to create a primarily rectangular railing section having approximately ten feet in length. While FIG. 5 is discussed in relation to three connected, ten-foot side rail portions 69, side rail portions 69 may have any appropriate length and/or configuration, and any number of side rail portions 69 may be employed along the length, L, of flatbed 54.

To connect side railing section 67 to flatbed 54, each side rail portion 69 may also include a number of attachment tabs 70. Attachment tabs 70 may be configured to slide within corresponding pockets 72, present on a rub rail 74 that runs along left and right sides 60, 62 of flatbed 54. In one embodiment, tabs 70 may be formed from 1.5-inch×3-inch box tubing. Depending on the sizing of existing pockets 72 within rub rail 74, tabs 70 may incorporate a plate steel shim (not shown) having a thickness that is appropriate to create a secure fit between tabs 70 and pockets 72, while still allowing for each side rail portion 69 to be manually installed and removed from pockets 72. In one embodiment, the shim may be formed of 3/16-inch plate steel. Side rail portions 69 may be coupled to one another via one or more pin joints 76. Each pin joint 76 may include a steel pin 75 having a ⅜-inch diameter, or any other suitable diameter and/or configuration.

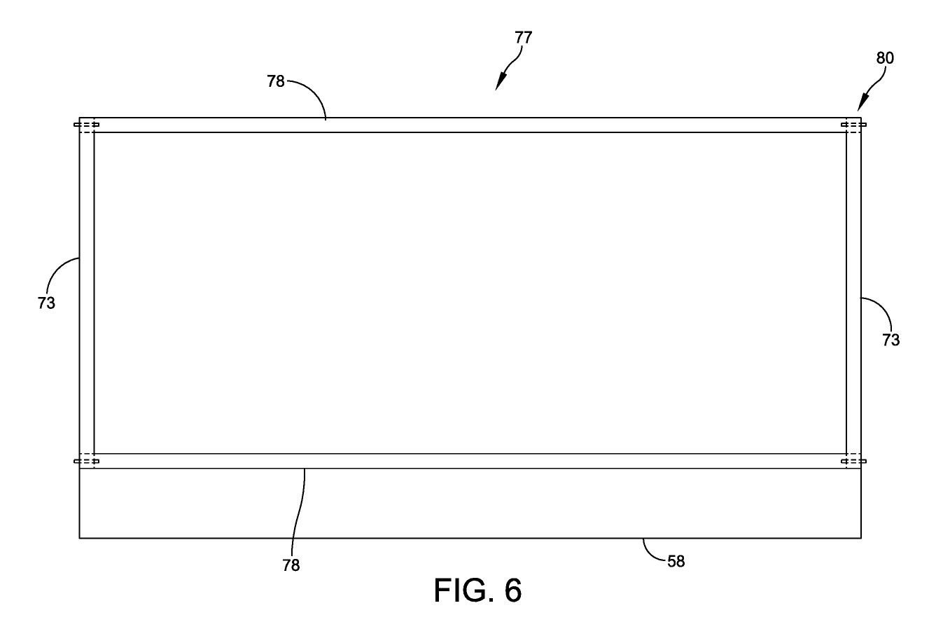

Protective structure 68 may continue around the perimeter of flatbed 54 from side sections 67 to back section 77, shown in FIG. 6. Back section 77 may include two end sections 78 that span the distance between side rail portions 69 at the top and the bottom. In one embodiment, each end section 78 may be formed from 2-inch×2-inch steel box tubing having any appropriate length (e.g., 8′ 1¾″).

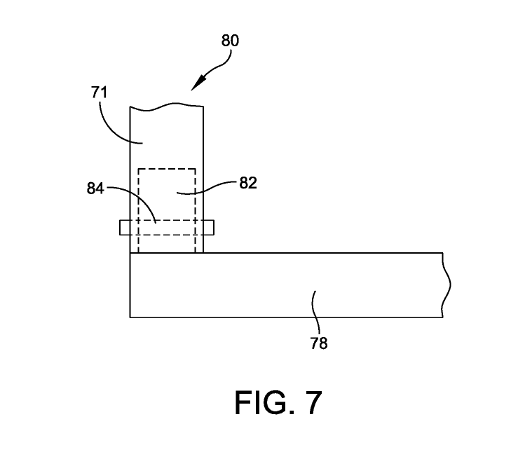

Each end section 78 may be secured to side railing sections 67. Specifically, each end section 78 may connect to lateral rails 71 of side rail portions 69 (FIG. 5) via two pinned joints 80. As detailed in the top-partial view of FIG. 7, each end of sections 78 may be fitted with an attachment tab 82, configured for insertion into the open ends of lateral rails 71, discussed above, which run along the side length of flatbed 54. Once attachment tab 82 is inserted within lateral rail 71, it may be pinned into place using a pin 84 configured to press fit within aligned apertures drilled through attachment tabs 82 and the ends of lateral rails 71. In one exemplary embodiment, attachment tabs 82 may be formed from 1¾-inch×1½-inch steel box tubing, sized to fit within the hollow 2-inch×2-inch tubing of lateral rails 71, and pin 84 may be a steel pin having a ⅜-inch diameter. Notably, all dimensions are exemplary, and lateral and vertical rails 71, 73, end sections 78, attachment tabs 82, and pin joint 80 may be formed of any appropriate material and may take any appropriate size, shape, type, and/or configuration.

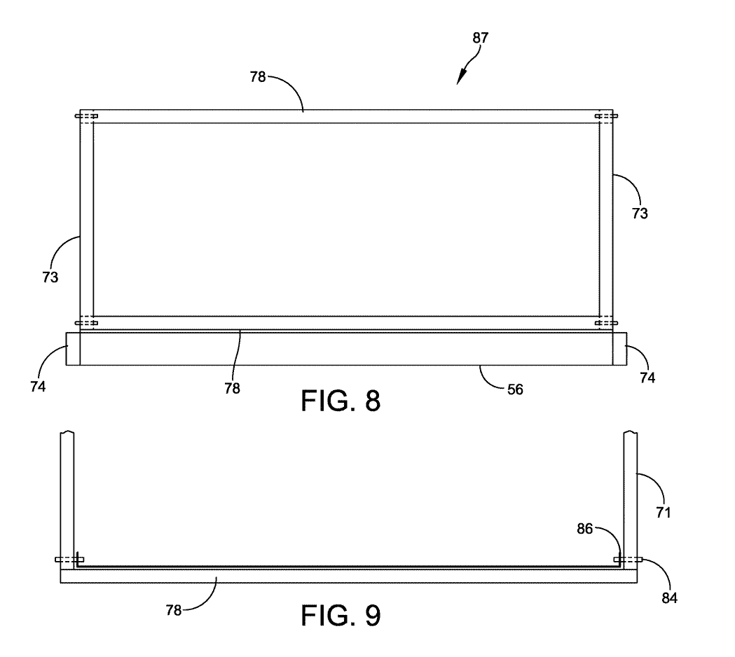

FIGS. 8-9 show respective front and top-partial views of one embodiment of a front railing section 87 of protective structure 68, as connected to side railing section 67. As an alternative to employing attachment tabs 82, as discussed above in relation to back section 77 of FIGS. 6-7, end sections 78 may be secured to lateral rails 71 through the use of an angle iron 86 (FIG. 9). Specifically, as shown in FIG. 9, angle iron 86 (or a shorter angle iron at each end) may be attached at each end of sections 78 and pinned into place using pin 84 in a manner that abuts end sections 78 against lateral rails 71 of side rail portions 69. In one embodiment, angle iron 86 may be formed from 2-inch angle iron of any appropriate length. This connection between front railing section 87 and side railing section 67 completes protective structure 68. Notably, pin joints 80 have been described in relation to attaching back railing section 77 to side railing section 67, while angle iron 86 has been described in relation to attaching front railing section 87 to side railing section 67. These attachment mechanisms are interchangeable and may be applied as appropriate to any joint on the trailer.

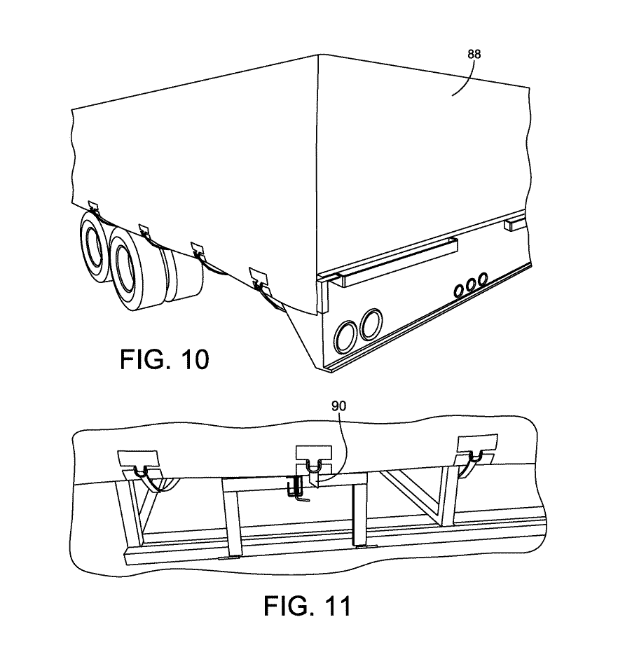

Protective structure 68 serves as both a railing system for safety purposes during sucker rod loading, discussed in further detail below, and as a support framework for a cover. FIG. 10 illustrates a perspective view of a removable cover 88 stretched over protective system 68 (not shown). As shown in FIG. 10, cover 88 may extend over front railing section 87, side railing sections 67, and back railing section 77 of protective structure 68. Cover 88 may be attached to front railing section 87 via a hook-and-loop connection system, such as, for example, a system of mating Velcro® strips. These strips may be attached to one or both end sections 78 along front end 56 of flatbed 54, as well as corresponding locations on cover 88. Cover 88 may be secured to the remainder of the trailer using a series of straps 90 (FIG. 11) affixed to the sides of flatbed 54. In one embodiment, industrial hook-and-loop strips may secure the corner junctions.

Cover 88 may be formed of a durable and flexible material that is water and chemical resistant (e.g., polyethylene). When in place, cover 88 provides loaded sucker rods with protection against environmental hazards such as, for example, rain, snow, dust, and other debris that have proven harmful to sucker rod performance and longevity.

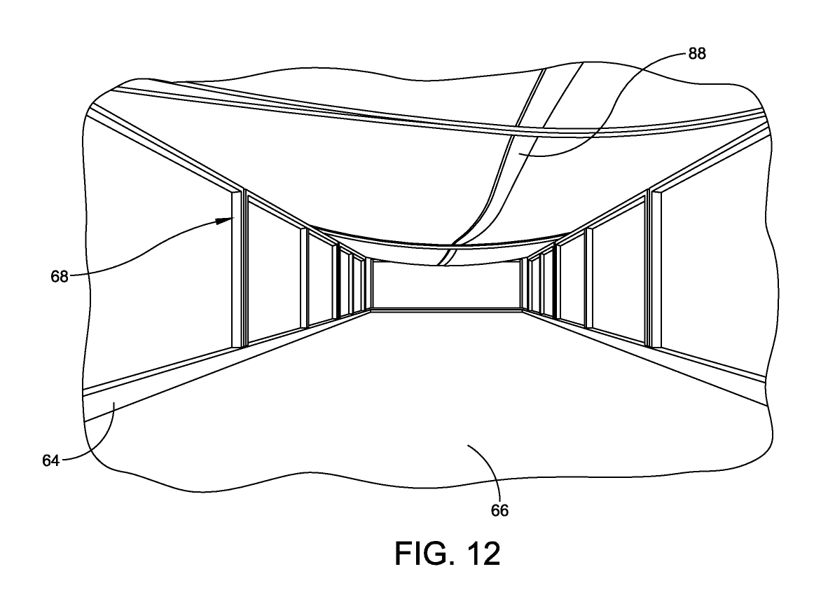

FIG. 12 illustrates a perspective view of the interior of the trailer when cover 88 is in place over protective structure 68. Notably, the material of cover 88 may also be used to line flatbed 54 and containment wall 64, thereby providing a chemical liner for fluid containment area 66, discussed above in relation to FIGS. 3-4.

In one embodiment, rod racks (not shown) may be installed upon flatbed 54 and within the footprint of protective structure 68 and cover 88 to allow proper spacing between stored sucker rods and to eliminate damaging metal-to-metal contact (e.g., grinding, rubbing, etc.).

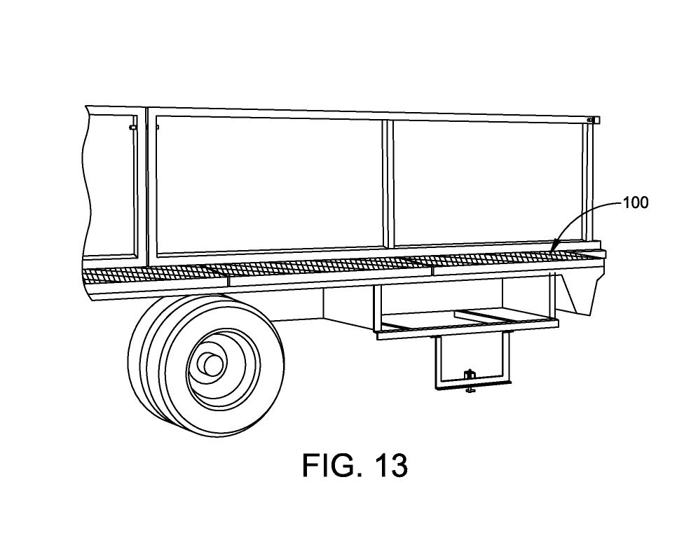

FIG. 13 illustrates a perspective view of one embodiment of a catwalk system 100 configured for attachment to rub rail 74 (FIG. 5). Embodiments of catwalk system 100 allow a rig crew to walk adjacent to the length of flatbed 54 while loading sucker rods, regardless of the height of the rod stack. Using catwalk system 100, rig crews may easily access the center of flatbed 54, allowing them to carefully and safely place each layer of sucker rods without the need to walk on top of lower layers, risking damage to the rods.

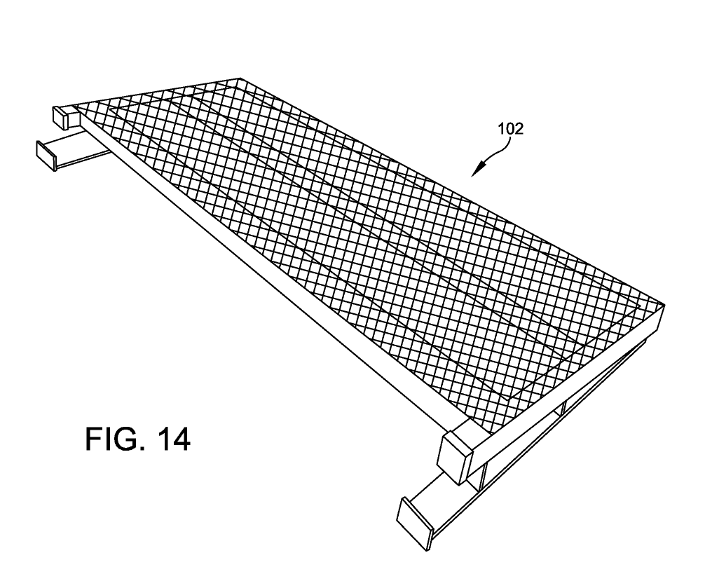

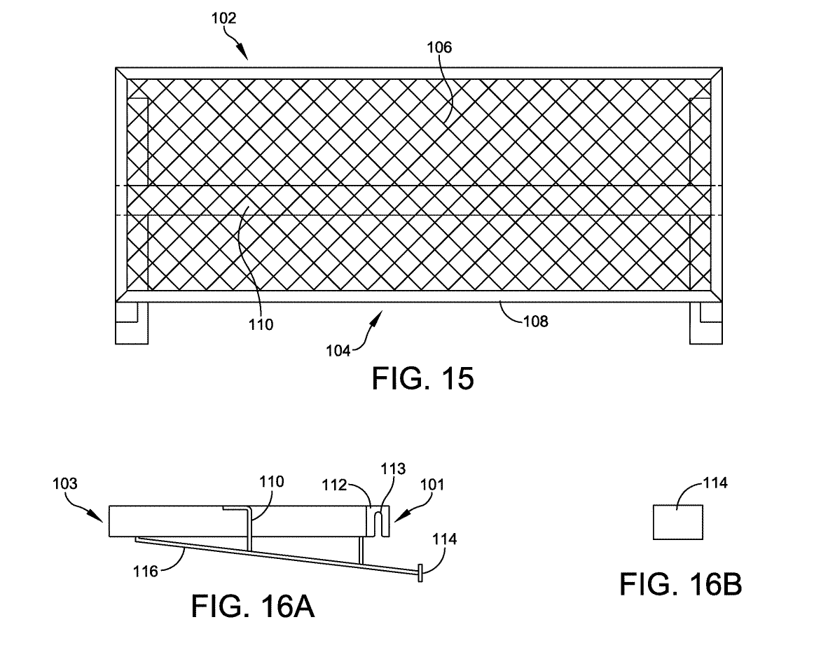

In one embodiment detailed in FIGS. 13-16, catwalk system 100 may include a number of individual and detachable catwalk sections 102. FIGS. 14-16 illustrate perspective, top, and side views, respectively, of one embodiment of an individual catwalk section 102. In this embodiment, each catwalk section 102 may include a support base 104 covered with an anti-slip walking surface 106 (e.g., expanded metal). In one embodiment detailed in FIG. 15, support base 104 may include a frame 108 bisected by a beam 110. Frame 108 may, in one embodiment, be formed from 2-inch C channel iron having a 4-foot×18-inch rectangular footprint, while beam 110 may be formed of 2-inch angle iron.

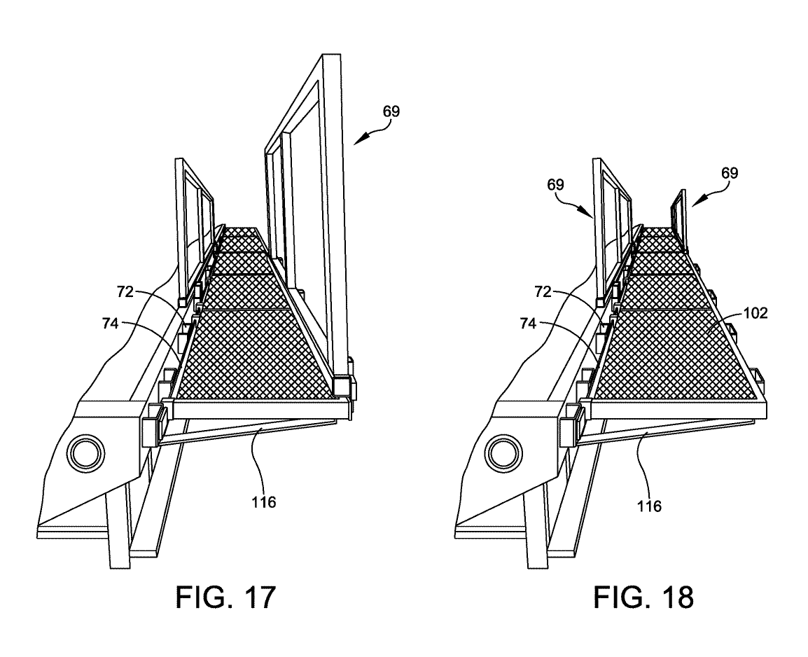

FIGS. 16A-B detail a mechanism by which each catwalk section 102 may attach to rub rail 74 (FIGS. 17-18). In one embodiment, catwalk section 102 may attach through a notched block 112 and a leverage block 114 (FIG. 16B). Notched block 112 may be located at a proximal edge 101 of catwalk section 102 and include a notch 113 configured to conveniently hook over/engage with an edge of rub rail 74, such that catwalk 102 protrudes in a parallel fashion from left and right sides 60, 62 of flatbed 54, as shown in FIGS. 17-18. The spacing between rub rail 74 and notch 113 in block 112 may allow for manual installation and removal of catwalk section 102.

One embodiment of leverage block 114 may sit at an end of a 2-inch×¾-inch strap steel arm 116 that angles away from a distal edge 103 of catwalk section 102, or from a position offset from distal edge 103 of catwalk section 102 (e.g., offset by 1½-inches or any appropriate distance), in a manner that allows for the positioning of leverage block 114 against a side of rub rail 74, again as shown in FIGS. 17-18. In one embodiment, arm 116 may be approximately 19 inches in length and may be supported at an angle via the angle iron of beam 110.

Leverage block 114 may be sized as appropriate to leverage support from rub rail 74, and, in one embodiment, may be formed of ¾-inch steel plate and form a 2-inch by ¾-inch rectangular footprint. In this regard, leverage block 114 may leverage the weight of catwalk section 102 against rub rail 74, adding additional vertical support for one or more users walking upon catwalk system 100. While catwalk system 100 and catwalk section 102 are described with an exemplary set of dimensions, the components of catwalk system 100 and catwalk section 102 may take any appropriate size, shape, and/or configuration to effectively suspend catwalk 102 from the side of flatbed 54.

As shown in FIGS. 17-18, the distal edge 103 of catwalk section 102 may be fitted with pockets similar to pockets 72 within rub rail 74, allowing side railing portions 69 of side railing sections 67 to optionally be moved to the outside of catwalk system 100 when catwalks 102 are installed. This repositioning of side rails 69 is demonstrated in FIGS. 17-18. In an alternative embodiment, side rail portions 69 may be configured to fold down and outward, such that they offer protective support when vertical and may be used as catwalks when horizontal.

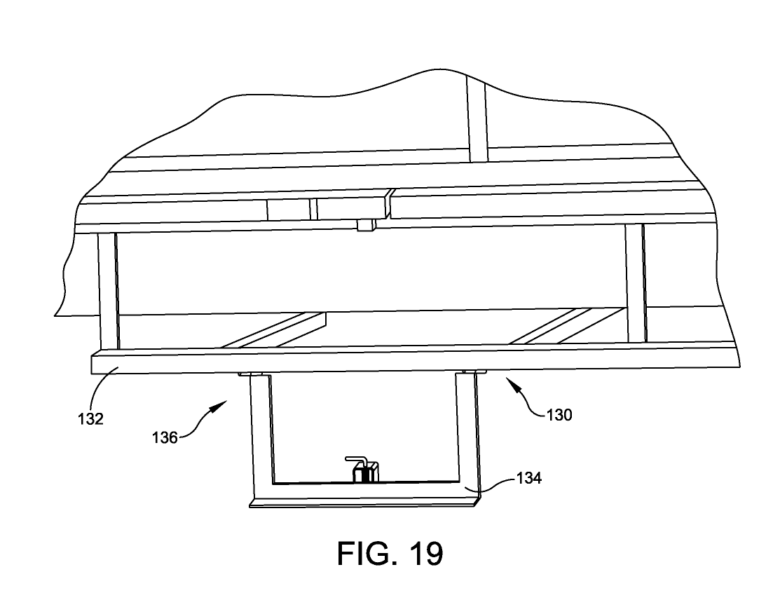

One embodiment of catwalk system 100 may include numerous removable catwalk sections 102. When not in use, catwalk sections 102 may be stored in hinged storage bins 130 located beneath flatbed 54. FIG. 19 illustrates a perspective view of one embodiment of a hinged storage bin 130. In further detail, and in this embodiment, each bin 130 may include a welded box structure 132 suspended from the bottom of flatbed 54. Box structure 132 may be formed from 2-inch angle iron and 2-inch box tubing, and have a hinged (e.g., a bullet hinge), latchable door 134 configured to secure/retain catwalk sections 102 when stored. Box structure 132 may be formed of numerous discrete boxes or a continuous box structure that runs the length of flatbed 54.

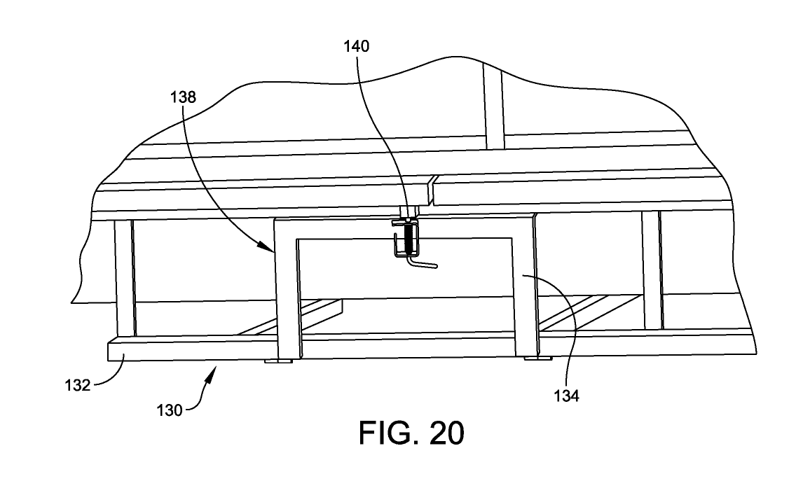

FIGS. 19-20 show perspective views of latchable door 134 in open and closed configurations 136, 138, respectively. A manual latch 140 having any appropriate configuration may secure latchable door 134 into the closed configuration 138. Box structure 132 and latchable door 134 may be dimensioned as appropriate to encompass/store a single catwalk section 102 or, alternatively, any number of desired catwalk sections 102. The particular dimensions and materials described may vary as appropriate and/or necessary.

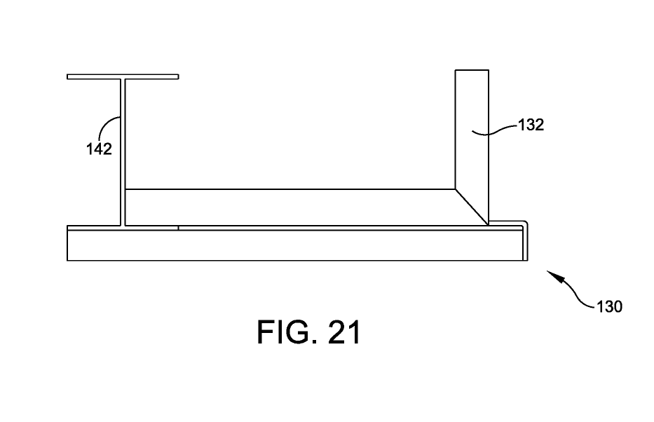

FIG. 21 illustrates a side view of box structure 132, as attached to a support I-beam 142 of base trailer 52 (FIG. 2). In one embodiment, box structure 132 may be welded to the undercarriage of trailer 52.

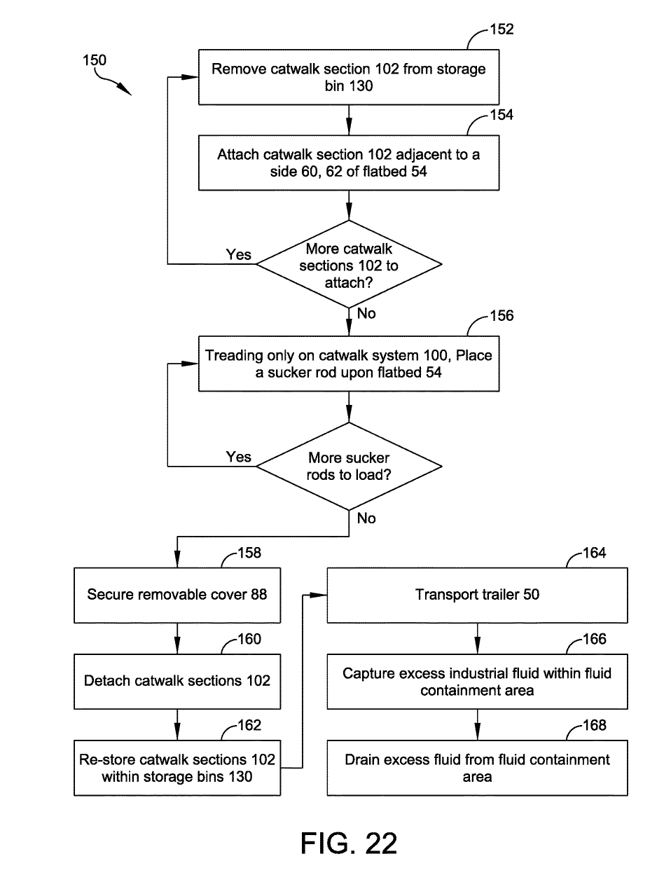

FIG. 22 provides a flow chart depicting an exemplary method 150 of storing and transporting sucker rods using sucker rod trailer 50. Method 150 initiates with the removal of a catwalk section 102 (152) from one of storage bins 130 suspended beneath flatbed 54 and attaching catwalk section 102 (154) adjacent to left side 60 of flatbed 54 (e.g., by engaging notches 113 of notched blocks 112 with rub rail 74). The steps of removing a catwalk section 102 from storage (152) and attaching catwalk section 102 adjacent to flatbed 54 may be repeated until all of catwalk sections 102 have been attached to form catwalk system 100.

Once catwalk system 100 is assembled, users may load trailer 50 with sucker rods. That is, by walking solely upon catwalk system 100, a rig crew may manually place a first sucker rod within fluid containment area 66 (156) of trailer 50. This step of loading a sucker rod (156) may be repeated until all the sucker rods have been loaded. Notably, by limiting human tread about trailer 50 to catwalk system 100, users do not walk upon flatbed 54 or within fluid containment area 66 and do not risk damage to the sucker rods as they stack up within the trailer. In on embodiment, one or more rod racks may be disposed upon flatbed 54, each being configured to separate the sucker rods from one another.

After the sucker rods are loaded, removable cover 88 may be secured about protective structure 68 and flatbed 54/fluid containment area 66 (158). Then catwalk sections 102 may be detached (160) from sides 60, 62 of flatbed 54 and re-stored (162) within storage bins 130 suspended beneath flatbed 54. With the sucker rods loaded and secure, trailer 50 may be transported (164) to a different location. At any time after loading (156), excess industrial fluid shed from the sucker rods during transport or applied to the sucker rods after loading may be captured within fluid containment area 56 (166) and drained (168) for proper disposal. In addition, while the steps of method 150 are described in a particular order for exemplary purposes, they may be performed in any appropriate and/or desired order.

Sucker rod trailer 50 provides features that resolve long-standing problems with sucker rod storage and maintenance. Protective structure 68 and cover 88 provide environmental protection (e.g., against moisture, humidity, extreme temperatures, etc.), and catwalk system 100 prevents rig crews from treading upon previously loaded rods. Both of these systems work to prevent corrupted, compromised threadings as well as micro fractures and nicks that can lead to premature failure of the rods. In sum, these systems also allow for safe, stable, and efficient loading, storage, and transportation procedures. Because sucker rod trailer 50 also includes a fluid containment mechanism to capture industrial fluids shed from sucker rods during loading, storage, and/or transport, fluids that have previously ended up as ground contaminants may be contained within the fluid containment area, drained, and appropriately disposed of. Use of sucker rod trailer 50 helps to ensure maximum life of sucker rods and, by association, sucker rod pumps.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A trailer system for storing and transporting sucker rods, comprising:
a flatbed having front, back, left, and right sides;
a protective structure protruding perpendicular to the flatbed along the front, back, left, and right sides; and
a detachable catwalk system protruding parallel to the flatbed along at least the left and the right sides, the catwalk system configured to support a number of users walking along the catwalk.

2. The trailer system of claim 1, wherein:
the protective structure comprises connected front, back, left side, and right side railing sections; and
the front, back, left side, and right side railing sections are configured as handrails for the users walking along the catwalk.

3. The trailer system of claim 1, further comprising a containment wall bordering the front, back, left side, and right side of the flatbed, wherein the containment wall and the flatbed combine to form a fluid containment area.

4. The trailer system of claim 3, further comprising a removable cover disposed about the protective structure such that the cover envelops the protective structure and the fluid containment area.

5. The trailer system of claim 1, wherein the detachable catwalk system comprises a number of catwalk sections, wherein each of the catwalk sections is detachably attached to a rub rail disposed along the flatbed of the trailer.

6. The trailer system of claim 5, wherein each of the catwalk sections comprises:
a base supporting a walking surface, the base having a proximal edge located proximal to the flatbed and a distal edge located distal to the flatbed;
a notched block located at the proximal edge of the base, the notched block having a notch configured to engage with the rub rail disposed along the flatbed;
a leverage arm angling away from the distal edge of the base, the leverage arm having a proximal end located proximal to the flatbed and a distal end located distal to the flatbed; and
a leverage block affixed to the proximal end of the leverage arm, the leverage block configured to abut the rub rail disposed along the flatbed.

7. The trailer system of claim 5, further comprising a plurality of storage bins disposed below the flatbed, each of the bins configured to stow at least one of the catwalk sections.

8. The sucker rod trailer of claim 7, wherein each of the storage bins comprises:
a box structure suspended from a bottom surface of the flatbed, the box structure sized to receive the at least one of the catwalk sections;
a hinged door;
a hinge configured to couple the hinged door to the box structure such that the hinged door moves between an open configuration and a closed configuration; and
a latch configured to secure the hinged door in the closed configuration.

9. A sucker rod storage and transportation trailer, comprising:
a flatbed sized to receive a number of sucker rods, the flatbed having front, back, left, and right sides;
a containment wall abutting the flatbed on the front, back, left, and right sides of the flatbed, the flatbed and the containment wall forming a fluid containment area;
a detachable catwalk system bordering the containment wall along at least the left and the right sides of the flatbed, wherein the detachable catwalk system includes a proximal edge and a distal edge relative to the containment wall, and wherein the detachable catwalk system is configured to support one or more users; and
a detachable protective structure having a left railing section disposed along the left side of the flatbed, a right railing section disposed along the right side of the flatbed, a front railing section disposed along the front side of the flatbed, and a back railing section disposed along the back side of the flatbed, the left and right railing sections configured to optionally attach at a proximal position located adjacent to the proximal edge of the detachable catwalk system and a distal position located adjacent to the distal edge of the detachable catwalk system.

10. The sucker rod storage and transportation trailer of claim 9, wherein the detachable catwalk system comprises a number of catwalk sections, each of the catwalk sections having a proximal edge and a distal edge relative to the containment wall.

11. The sucker rod storage and transportation trailer of claim 10, wherein each of the catwalk sections is configured for manual attachment to and detachment from a rub rail disposed along the front, back, left, and right sides of the flatbed.

12. The sucker rod storage and transportation trailer of claim 11, wherein each of the catwalk sections comprises:
a base supporting a walking surface;
a notched block located at the proximal edge of the catwalk section, the notched block having a notch configured to engage with the rub rail;
a leverage arm angling away from the distal edge of the catwalk section, the leverage arm having a proximal end located proximal to the rub rail and a distal end located distal to the rub rail; and
a leverage block affixed to the proximal end of the leverage arm, the leverage block configured to abut the rub rail.

13. The sucker rod storage and transportation trailer of claim 11, further comprising a number of storage bins disposed beneath a bottom surface of the flatbed, each of the storage bins sized to receive one of the catwalk sections.

14. The sucker rod storage and transportation trailer of claim 13, wherein each of the storage bins comprises:
a box structure suspended from the bottom surface of the flatbed, the box structure sized to receive the one of the catwalk sections;
a hinged door;
a hinge coupled between the hinged door and the box structure, the hinge configured to allow movement of the hinged door between an open configuration and a closed configuration; and
a latch configured to secure the hinged door in the closed configuration.

15. The sucker rod storage and transportation trailer of claim 9, further comprising a removable cover configured to envelop the detachable protective structure and the fluid containment area.

16. A method of storing and transporting sucker rods using a sucker rod trailer having (1) a flatbed sized to receive the sucker rods, the flatbed having front, back, left, and right sides surrounded by a containment wall, the flatbed and the containment wall combining to form a fluid containment area; and (2) a protective structure disposed about the containment wall, the method comprising:
removing, from one of a number of storage structures suspended beneath the flatbed, a catwalk section selected from a number of catwalk sections;
attaching the catwalk section adjacent to the left or the right side of the flatbed;
repeating the removing the catwalk section and the attaching the catwalk section until a catwalk system protrudes parallel to the left and the right sides of the flatbed in a manner that supports one or more users;
walking solely upon the catwalk system, placing a sucker rod within the fluid containment area; and
repeating the placing the sucker rod until all the sucker rods are stacked within the fluid containment area.

17. The method of claim 16, further comprising securing a removable cover about the protective structure and the flatbed.

18. The method of claim 16, further comprising:
detaching each of the catwalk sections from the left and the right sides of the flatbed; and
storing the catwalk sections within the storage structures suspended beneath the flatbed.

19. The method of claim 18, further comprising transporting the sucker rod trailer from a first location to a second location.

20. The method of claim 19, further comprising:
capturing excess fluid shed from the sucker rods within the fluid containment area; and
draining the excess fluid from the fluid containment area.
